(19) United States
(12) Patent Application Publication
(10) Pub. No.: US 2023/0112655 A1
(43) Pub. Date: Apr. 13, 2023

(54) System and Method for a Mobile User Interface

(71) Applicant: Michael T. Diep, Fountain Valley, CA (US)

(72) Inventor: Michael T. Diep, Fountain Valley, CA (US)

(21) Appl. No.: 17/499,592

(22) Filed: Oct. 12, 2021

(51) Int. Cl. G06F 3/0482; G06F 3/0485; G06F 3/0488; H04M 1/72445

(52) U.S. Cl. CPC G06F 3/0482; G06F 3/0485; G06F 3/04886; H04M 1/72445

(57) ABSTRACT

A mobile computer device is disclosed for displaying one or more internet content comprising GPU-controlled screen and an software module that comprises: a viewing module for the user to view the internet content; the viewing module further comprises; a content module that provides a content to a user; an embedded control menu module that is comprised of control function tool bar which is embedded and fixed to the content; wherein as the content moves up and down as it is being scrolled by the user, the embedded content moves up and down along the content; a split screen control menu module that is comprised of control function tool bar that does not appear on the viewing module until when the embedded control module is scroll out of the available viewing space of the viewing module; wherein once the split screen control menu module appear on the viewing module it does not move up and down along the content as it is being scrolled up and down by the user.

### FIELD OF THE INVENTION

The present invention is directed generally to a system and method of consumption data collection and mining, and advertisement generation, using Pace Ready Technology (PRT). Specifically, it is directed to a PRT-enabled system and method to collect, analyze, and discover online readers' consumption preferences, and to promote targeted advertisement.

### BACKGROUND OF THE INVENTION

Today more than 88.5% US population uses the Internet and mobile broadband for a variety of purposes: connecting with family and friends, shopping, getting news, and searching for information. Furthermore, about 99% of the 18-to-29 age group uses the Internet for the foregoing purposes. This statistic is very significant because it indicates that almost all young adults spend time on the Internet. Equally significant is that this 18-to-29 age group is the consumer group all advertisers and businesses love because they begin to have incomes for their consumption demands, and likely develop brand loyalty lasting for at least the next 20 years, to 50 years old or beyond. Obviously, to develop and seize the 18-to-29 age group's brand loyalty is the objective of the online advertisers and businesses.

Businesses know these facts and race to have a present on the Internet and mobile devices, and compete to attract the larger share of the consumers to their sites and mobile applications. Businesses attract consumers by providing useful information, useful products, or good prices, etc.. However, all the useful and attractive utilities of the information will be negated or canceled out if the consumers experience a sluggish and/or counter-intuitive website. There are existing Internet and mobile applications that are not responsive or intuitive.

Applications on mobile devices further demands specific design considerations due to their smaller digital display. The smaller display can only show a limited amount of content at a time. Without an innovation, there are existing mobile applications that force the users to scroll up and down multiple times to view or access the content or certain features. For example, some mobile applications force the users, after viewing multiple screens of a long content, to scroll back up to the beginning of the content to access the application's command menu. To alleviate this problem, some applications put a duplicate command menu at the end of the content to save the users' time. However, this solution is also not thought through because quite often the users want to navigate away from the content in the middle thereof without finishing viewing the whole content.

For all the foregoing needs for ever attract more and more consumers to a mobile application, a new innovative system and method of navigating mobile content are desirable.

### OBJECT OF THE INVENTION

Accordingly, it is an object of this invention to provide an innovative system and method to navigate mobile content.

It is an object of the invention to provide a control menu tool bar on the viewing area that is fast and moves with the content and reappears at the bottom of the viewing area when the original control menu tool bar is moved outside of the viewing area.

### SUMMARY OF INVENTION

In the present invention, a system and method for browsing one or more internet content by an user is disclosed, comprising an application embedded within the mobile device, the application comprising: a viewing module for the user to view the internet content; an automatic scrolling module wherein the scrolling module moves the internet content up in desired interval; a data gathering module that gathers data of the interaction between the user and the automatic scrolling module and the internet content.

In one aspect of the invention, a mobile computer device is disclosed for displaying one or more internet content comprising GPU-controlled screen and an software module that comprises:

a viewing module for the user to view the internet content; the viewing module further comprises; a content module that provides a content to a user; an embedded control menu module that is comprised of control function tool bar which is embedded and fixed to the content; wherein as the content moves up and down as it is being scrolled by the user, the embedded content moves up and down along the content; a split screen control menu module that is comprised of control function tool bar that does not appear on the viewing module until when the embedded control module is scroll out of the available viewing space of the viewing module; wherein once the split screen control menu module appear on the viewing module it does not move up and down along the content as it is being scrolled up and down by the user. In one embodiment, the software module of claim 1 where the split screen control menu module is removed from the viewing module once the embedded control menu reappears into the viewing module.

### BRIEF DESCRIPTION OF THE DRAWINGS

These and other features and advantages of the invention will not be described with reference to the drawings of certain preferred embodiments, which are intended to illustrate and not to limit the invention, and in which FIG. 1 illustrates a home or first screen of an embodiment of the current invention.

FIG. 2 illustrates a continuous page of an embodiment of the current invention where the menu bar is scrolled along with the content and positioned between the bottom and top of the screen.

FIG. 3 illustrate another page of an embodiment of the currant invention where the menu bar is at the top of the screen.

FIG. 4 illustrates another page of an embodiment of the current invention where as the page scrolls off the top of the sreen the menu bar appears at the bottom of the screen.

FIG. 5 is an exemplary flowchart of an embodiment of the current invention.

### DETAILED DESCRIPTION OF THE INVENTION

Some embodiments are described in detail with reference to the related drawings. Additional embodiments, features, and/or advantages will become apparent from the ensuing description or may be learned by practicing the invention. The following description is not to be taken in a limiting sense, but is made merely for the purpose of describing the general principles of the invention. The steps described herein for performing methods form one embodiment of the invention, and, unless otherwise indicated, not all of the steps must necessarily be performed to practice the invention, nor must the steps necessarily be performed in the order listed. It should be noted that references to “an” or “one” or “some” embodiment(s) in this disclosure are not necessarily to the same embodiment, and such references mean at least one.

The present invention has been conceived with the aim of addressing one or more problems of current mobile devices' screens due to the smaller screen sizes.

FIG. 1 illustrates a sample of typical mobile user interface for content browsing and navigating 100, consisting of a display 101, a home control menu 110 that comprises a Home button 111, a News button 112, a Messenger button 113, an Add button 114, a Rating button 115, a Contest button 116, and a Profile button 117. A portion of a web content is shown on the display 101. Typically, the home control menu is either embedded in the content page or it is a split screen from the content page.

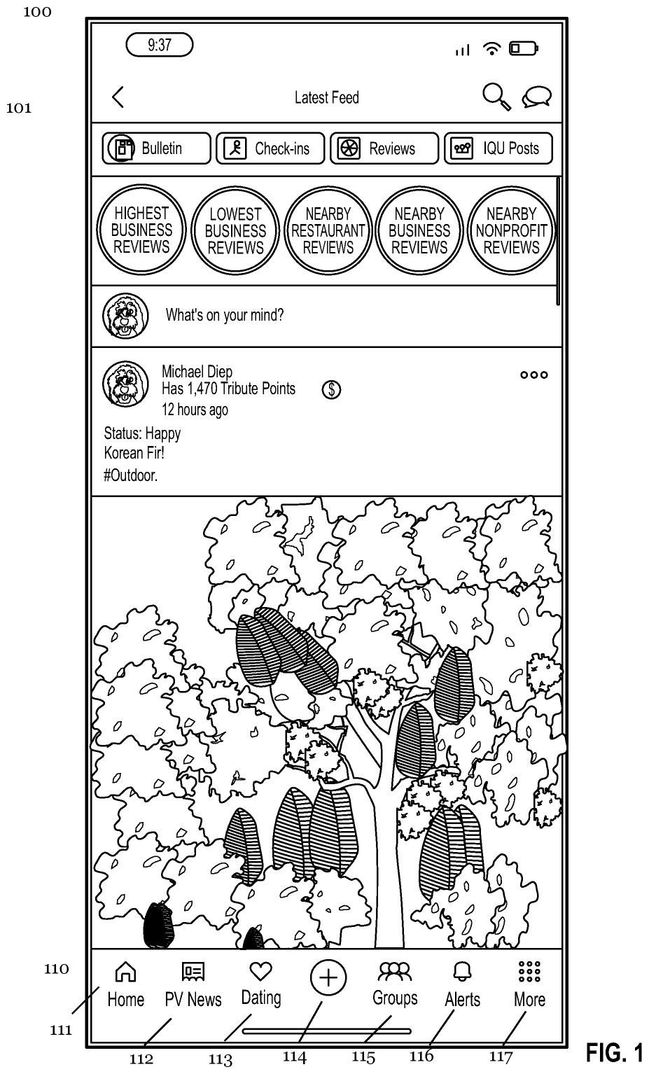

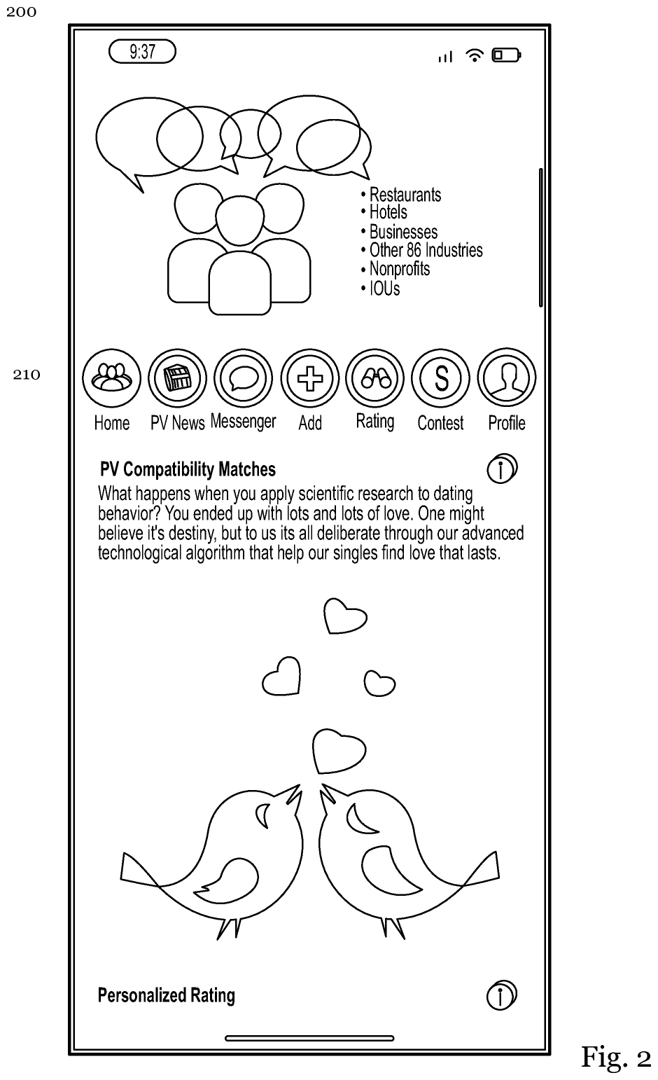

FIG. 2 illustrates the current embodiment 200 of the current invention where the screen displays a long web content which spans multiple screens, In FIG. 2, the long web content is scrolled up to show the lower part of the first page and the upper part of the second page. The embedded control menu 210 is moved up along with the content, and, now, positions at about the midsection of the screen. It follows that as the user continues to scroll the web content, the control menu 210 will eventually scrolls off the screen.

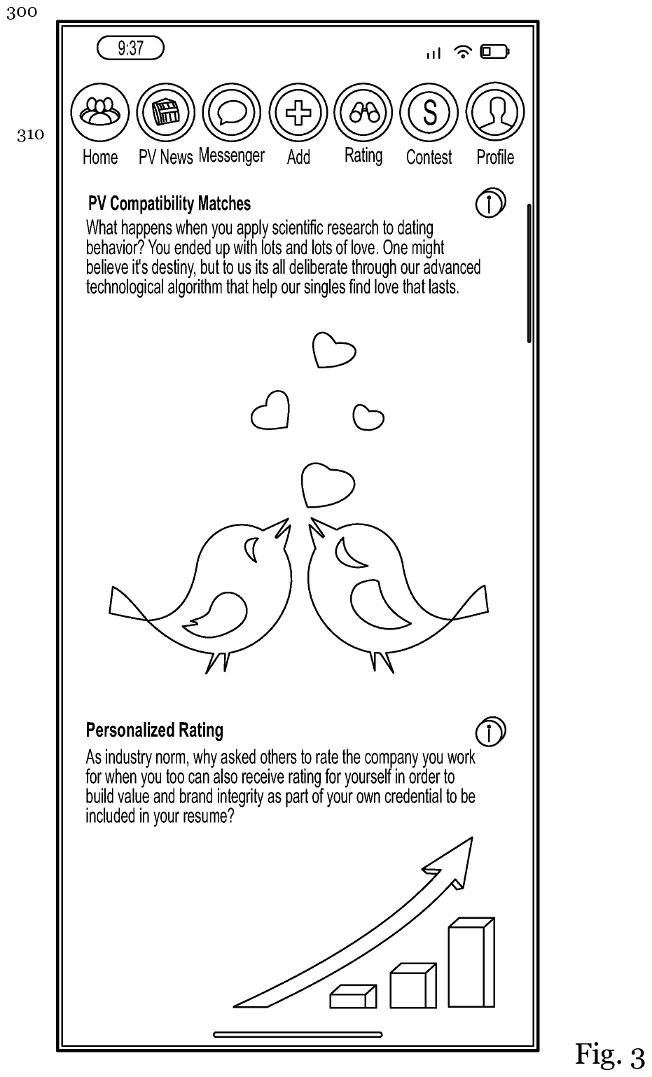

FIG. 3 illustrates another embodiment 300 of the current invention. This embodiment displays a second page of a long web content where the user has scrolled past the entire first page. The embedded control menu 310 now positions at the top of the screen/display.

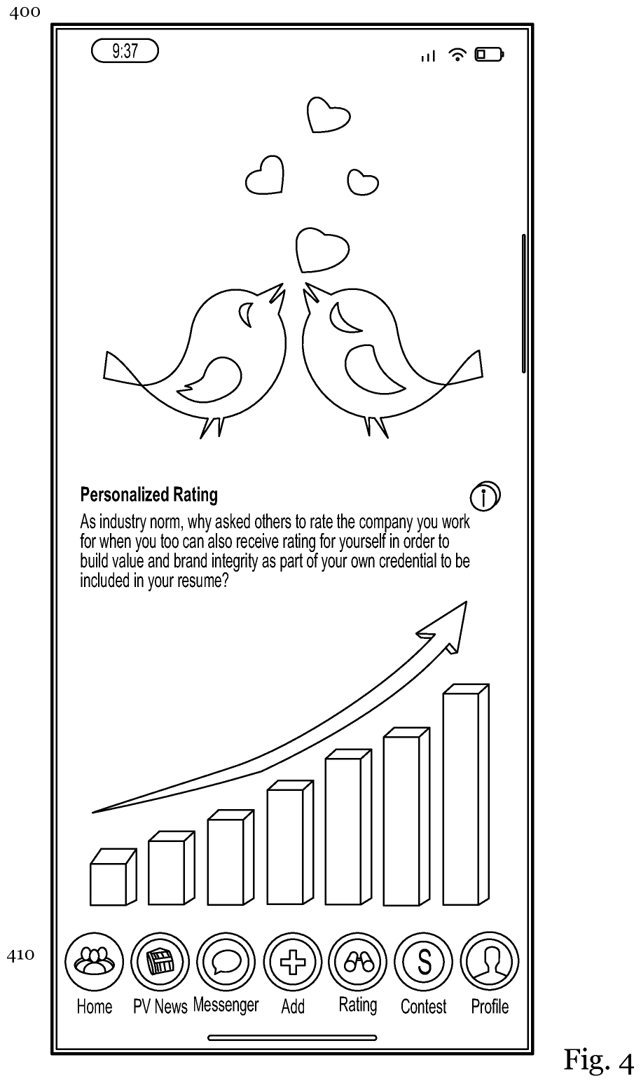

FIG. 4 illustrates another embodiment 400. As the user continues scrolling the content and the embedded control menu 310 disappears into the top edge of the display, The split screen control menu 410 now appears at the bottom of the display as depicted in FIG. 4. In this embodiment, the split screen control menu 410 appear as split screen so as the long web content continues to scroll up and now the split screen control menu 410 now stays fixed at the bottom of the screen as oppose to be moving along with the content. The current invention tracks the control menu's position and keeps it always visible and accessible on the display for the user. This implementation prevents unnecessary scrolling to look for the control menu once it is scrolled off the display, and, thus, saves the user's time and attention. The benefit of this unique invention is that

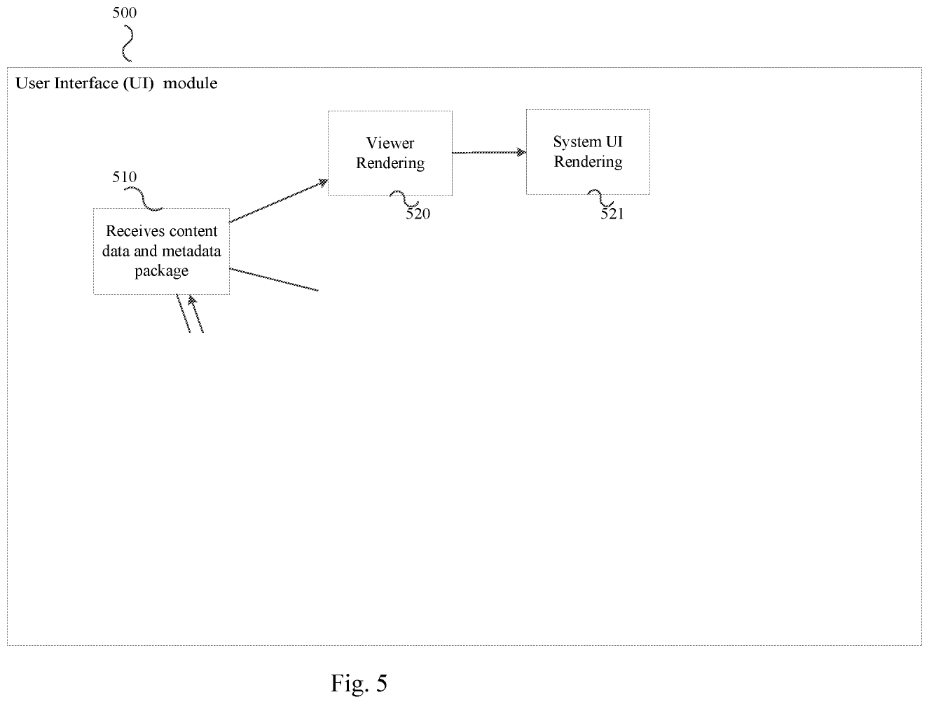

FIG. 5 is a flowchart of the display control, aka., UI, module 500 that comprises a content processor module 510 that receives the web content and its metadata from a source. The content module 510 formats the content according the user's predefined settings and paginates it, given the format metadata and the system display size. The content module then instructs the viewer rending module 520 to display the formatted content. The viewer rendering module, in turn, instructs the system UI rendering 521 to display the content on the screen. In one embodiment, the content module 510 instructs the viewer module 520 to embed the control menu in each page of the content at the bottom of the page, In this implementation, as the user scrolls the content up to view more, the paginated content with the embedded instances of the control menu are scrolled along.

1. A mobile computer device for displaying one or more internet content comprising GPU-controlled screen and an software module that comprises:
a) a viewing module for a user to view said internet content;
b) said viewing module further comprises;
c) a content module that provides a content to said user;
d) an embedded control menu module that is comprised of a first control function tool bar which is embedded and fixed to said content;
e) wherein as said content moves up and down as it is being scrolled by said user, said embedded content moves up and down along said content;
f) a split screen control menu module that is comprised of a second control function tool bar wherein said tool bar is capable of controlling and navigating said content which does not appear on said viewing module until when said embedded control menu module is scrolled out of the available viewing space of said viewing module;
g) wherein once said split screen control menu module appear on said viewing module it does not move up and down along said content as it is being scrolled up and down by said user.

2. The mobile computer device of claim 1 where said split screen control menu module is removed from said viewing module once said embedded control menu module reappears into the viewing module.
